(19) United States
(12) Patent Application Publication
(10) Pub. No.: US 2014/0039986 A1
(43) Pub. Date: Feb. 6, 2014

(54) IDENTIFYING CONTRIBUTIONS TO TRANSPORTATION SYSTEM SCHEDULE DEVIATION

(71) Applicant: John C. Handley, Fairport, NY (US)

(72) Inventor: John C. Handley, Fairport, NY (US)

(73) Assignee: XEROX CORPORATION, Norwalk, CT (US)

(21) Appl. No.: 13/563,001

(22) Filed: Jul. 31, 2012

(51) Int. Cl. G06Q 10/04

(52) U.S. Cl. 705/7.42

(57) ABSTRACT

A method and a device for identifying factors that contribute to schedule deviation in a transportation system are disclosed. The method includes collecting operating information for a vehicle along a transportation route and determining schedule deviation information for the transportation route based upon the operating information. A plurality of models is constructed, each of the plurality of models including at least one combination of factors that contribute to schedule deviation, and the models are ranked. As results sets is produced that includes at least the highest ranked model showing at least one combination of factors that most contributes to schedule deviation, The results set is presented and an operator associated with the transportation system may institute one or more changes to the system. The device includes at least a processing device and computer readable medium containing a set of instructions configured to cause the device to perform the method.

### BACKGROUND

The present disclosure relates to identifying contributions to schedule slippage average and standard deviation in a transportation system, such as a public bus, train or plane system. More specifically, the present disclosure relates to regression modeling for identifying driver contributions to schedule slippage average and standard deviation.

Many service providers monitor and analyze analytics related to the services they provide. For example, computer aided dispatch/automated vehicle location (CAD/AVL) is a system in which public transportation vehicle positions are determined through a global positioning system (GPS) and transmitted to a central server located at a transit agency's operations center and stored in a database for later use. The CAD/AVL system also typically includes two-way radio communication by which a transit system operator can communicate with vehicle drivers. The CAD/AVL system may further log and transmit incident information including an event identifier (ID) and a time stamp related to various events that occur during operation of the vehicle. For example, for a public bus system, logged incidents can include door opening and closing, driver logging on or off, wheel chair lift usage, bike rack usage, current bus condition, and other similar events. Some incidents are automatically logged by the system as they are received from vehicle on-board diagnostic systems or other data collection devices, while others are entered into the system manually by the operator of the vehicle.

For a typical public transportation company, service reliability is defined as variability of service attributes. Problems with reliability are ascribed to inherent variability in the system, especially demand for transit, operator performance, traffic, weather, road construction, crashes, and other similar unavoidable or unforeseen events. As transportation providers cannot control all aspects of operation owing to these random and unpredictable disturbances, they must adjust to the disturbances to maximize reliability. Several components that determine reliable service are schedule adherence, maintenance of uniform headways (e.g., the time between vehicles arriving in a transportation system), minimal variance of maximum passenger loads, and overall trip times. However, most public transportation companies put a greater importance on schedule adherence.

By using a CAD/AVL system, transit operators can easily obtain current and historical operation information related to a vehicle or a fleet of vehicles. However, the information shows an overall trend of the data, not individual data related to specific incidents that may occur during the operation of a vehicle. For example, the historical information may show how well a vehicle adhered to a set schedule over a period of time (e.g., three months), but the information does not provide an easy way to determine cause of unreliability and the relationship between reliability and passenger travel behavior, nor does the information provide an understanding of the effect of unreliability on operational costs.

### SUMMARY

In one general respect, the embodiments discloses a method of identifying factors that contribute to schedule deviation in a transportation system. The method includes collecting, at a processing device, operating information related to the operation of a vehicle along a transportation route; determining, at the processing device, schedule deviation information for the transportation route based upon the operating information, the schedule deviation information comprising at least an identification of a driver and a sequence number; constructing, by the processing device, a plurality of models, each of the plurality of models including at least one combination of factors that contribute to schedule deviation; ranking, by the processing device, each of the plurality of models according to at least one information criterion; assessing, by the processing device, an impact of the driver and the sequence number on a highest ranked model to produce a results set, wherein the results set comprises at least a highest ranked model showing at least one combination of factors that most contributes to schedule deviation; and presenting, by the processing device, the results set.

In another general respect, the embodiments disclose a device for predicting a future occurrence of a transportation system incident. The device includes at least a processor and a computer readable medium containing a set of instructions. The instructions are configured to instruct the processor to collect operating information related to the operation of a vehicle along a transportation route, determine schedule deviation information for the transportation route based upon the operating information, the schedule deviation information comprising at least an identification of a driver and a sequence number, construct a plurality of models, each of the plurality of models including at least one combination of factors that contribute to schedule deviation, rank each of the plurality of models according to at least one information criterion, assess an impact of the driver and the sequence number on a highest ranked model to produce a results set, wherein the results set comprises at least a highest ranked model showing at least one combination of factors that most contributes to schedule deviation, and present the results set.

In another general respect, the embodiments disclose an alternative method of identifying factors that contribute to schedule deviation in a transportation system. The alternative method includes collecting, by a processing device, operating information related to the operation of a vehicle along a transportation route, wherein the operating information comprises at least timing information and geographic information for the vehicle along the transportation route; determining, by the processing device, schedule deviation information for the transportation route based upon the operating information, the schedule deviation information comprising at least an identification of a driver of the vehicle and a sequence number for the transportation route; constructing, by the processing device, a plurality of models, each of the plurality of models including at least one combination of factors that contribute to schedule deviation, the factors comprising at least the driver and the sequence number; ranking, by the processing device, each of the plurality of models according to at least one information criterion; assessing, by the processing device, an impact of the driver and the sequence number on a highest ranked model to produce a results set; and implementing the at least one suggested action.

### BRIEF DESCRIPTION OF THE DRAWINGS

FIG. 1 depicts a box plot according to an embodiment.

FIG. 2 depicts a contingency table according to an embodiment.

FIG. 3 depicts a graph illustrating how sequence number for a route affects schedule reliability according to an embodiment.

FIGS. 4a and 4b depict a set of graphs illustrating how drivers affect schedule reliability according to an embodiment.

FIG. 5 depicts a sample flow chart for collecting and displaying various data related to the operation of a transportation vehicle according to an embodiment.

FIG. 6 depicts a sample flow diagram of a method for identifying contributions to schedule slippage average and standard deviation.

FIG. 7 depicts various embodiments of a computing device for implementing the various methods and processes described herein.

### DETAILED DESCRIPTION

This disclosure is not limited to the particular systems, devices and methods described., as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, a “computing device” refers to a device that processes data in order to perform one or more functions. A computing device may include any processor-based device such as, for example, a server, a personal computer, a personal digital assistant, a web enabled phone, a smart terminal, a dumb terminal and/or other electronic device capable of communicating in a networked environment. A computing device may interpret and execute instructions.

A “regression model” is a model based upon an analysis of several variables using regression analysis techniques to determine a relationship between a dependent variable and one or more independent variables.

The present disclosure is directed to a method and system for analyzing data from a service provider, such as a public transportation system service provider. For example, public transportation companies monitor quality of service analytics related to how a transit system is performing. Generally, the analytics reflect average performance of the transit system, variation of the performance over time, and a general distribution of performance over time. For a public transportation system, low quality of service can result in decreased ridership, higher costs and imbalanced passenger loads. As performance variability increases, waiting times also increase, thereby directly impacting customer satisfaction. From a passenger perspective, reliable service requires origination and destination points that are easily accessible, predictable arrival times at a transit stop, short running times on a transit vehicle, and low variability of running time. Poor quality of service can result in passengers potentially choosing another transportation option, thereby hurting the public transportation company potential income.

Various factors may contribute to deviation from a set schedule. Schedule adherence may be assessed by monitoring schedule deviation at a number of time points along a set schedule. For example, a set of stops along a bus route may be monitored. Statistics may be collected for an individual trip, which is a route that is run according to a set schedule. The statistics may be collected over a period of time (e.g., three months) and trends may be identified in the statistics indicating one or more contributions of deviation from the schedule.

In an embodiment, a transportation system may use a computer aided dispatch/automated vehicle location (CAD/AVL) system to monitor and store data that is used to determine a historical statistics for a particular route (e.g., later arrivals at a transit stop, wheelchair loading/unloading, bike rack loading/unloading). The present disclosure further provides creating of a plot of the historical statistical information and fitting one or more count regression models to the plot. The model fit may be assessed to determine one or more contributions to schedule deviation for the route.

Analysis of schedule deviation may be shown in terms of mean and coefficient of variation (standard deviation/mean). What this may offer is: 1) simultaneous estimation of regression coefficients for mean and variance using generalized additive models with location scale and shape; and 2) ranking of models using Bayesian Information Criterion (BIC) to determine a best model.

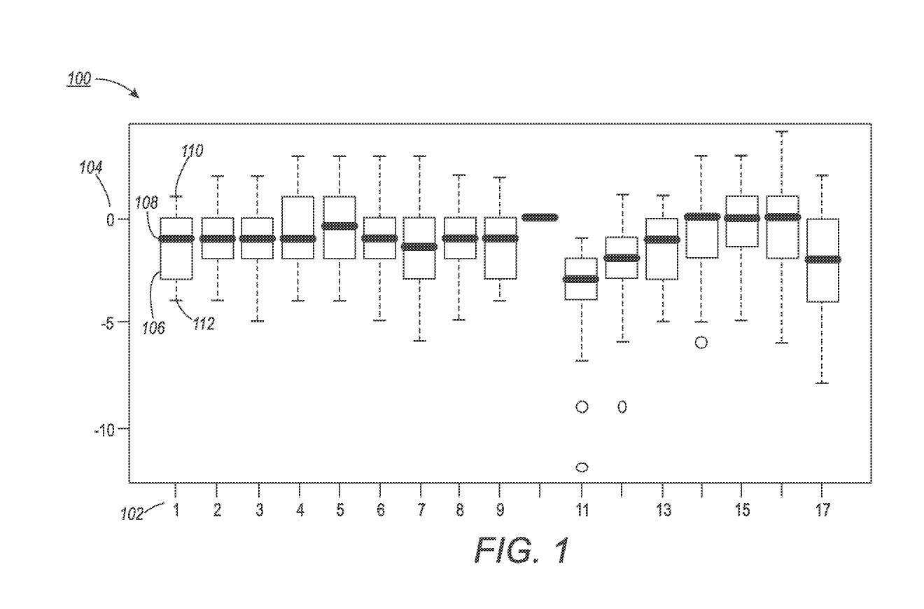

FIG. 1 illustrates a box plot 100 showing schedule deviation as a function of time for a specific route. For example, as shown in FIG. 1, the y-axis 102 may include a set of points along a specific route. The x-axis 104 may show the deviation from the set schedule for that route, measured in minutes. For each point along the route, a box (e.g., box 106) may indicate various historical statistics for that point. For example, the horizontal black line 108 in the box 106 may indicate the median deviation for that point. The box 106 itself may indicate a 25%-75% deviation range for that point. And the dashed lines 110, 112 may indicate the minimum deviation (110) and the maximum deviation (112) for that point.

Schedule adherence may change as a function of sequence number (e.g., in what order are the points on the route reached) as well as both average and standard deviation for that route. To assess how well buses are adhering to published schedules, certain bus stops on a route may be designated as time points along the route. At these time points, the arrival time of a bus may be measured. The actual arrival time as measured may be subtracted from the scheduled arrival time to calculate a schedule deviation at a given time point. On a typical trip along the bus route, a bus encounters each time point in order. The sequence number may be the number assigned to the time points in order. The first time point may have a sequence number 1 and the last time point may have a sequence number equal to the number of time points. For example, if there are 17 measured time points, such as the example as shown in FIG. 1, the last time point may be assigned sequence point 17.

It may be of interest to the operations management of the transit system how the schedule deviation changes as a bus progresses through the sequence numbers. It may be expected that the mean and variance of the schedule deviation resulting from sequence number changes according to the time points. For example, one may expect that the schedule would slip as sequence number increases, and the schedule deviation would increase accordingly, because the lateness tends to accumulate along the route. Further, it might be expected that the variance of the deviation would increase as bus drivers over-compensate for lack of schedule adherence by speeding up or slowing down.

Operations managers may want to know what contributes to the lateness (or earliness) of a bus. As in any such operations analysis, a statistical model may be built to assess the affect of a number of factors. Some factors, such as traffic and road construction are beyond the ability of the driver to control. These effects may appear in the data as variation that is outside the model.

Conversely, the driver's behavior and ability may play a crucial role in schedule adherence as it is something that can be at least partially controlled by incentives and training. However, the effect of the driver needs to be determined statistically by controlling and modeling other effects. As discussed above, another prominent effect that can be measured is the sequence number and how each sequence number impacts schedule deviation. That is, the deviation may be measured at each time point along the route. Further, it may possible that one of the time points is a layover during which bus drivers switch and the bus may pause to get back on schedule. For example, as shown in FIG. 1, time point 10 may be a layover used to change drivers.

It may be useful to not only assess the effect of the sequence number and driver on the mean or average schedule deviation, but also on the standard deviation of the schedule deviation. In particular, a poor performing driver may have an average arrival time that was too late or too early, but would also have a high standard deviation. The latter may be an indication of the driver's inability to provide a consistent schedule adherence and adversely affect the experience of passengers. Thus it is desired to simultaneously account for the effect of sequence number and driver on the mean and variance (both average and standard deviation).

To determine a statistical model, such as a regression model, deviation may be determined by:

deviation˜N(μ=β₀+β₁seq_num+β₂driver_id, σ=γ₀+γ₁seq_num+γ₂driver_id)

where mu represents the mean and sigma represents the standard deviation. Thus, in order to calculate the deviation, both the sequence number and bus driver may affect mean derivation from the schedule and the standard deviation of schedule deviation. Conventionally, it is unknown whether any or all of the sequence number or driver id inputs affect mean or standard deviation. However, using one or more models, such as a regression model including all combinations of the contributing factors, may be fitted by maximum likelihood or Bayesian techniques. An example of a maximum likelihood technique is the R package for generalized additive models with location scale and shape (GAMLSS). A key feature of the model as determined using a maximum likelihood technique such as GAMLSS is that it extends the regression model to include covariates for the standard deviation in addition to the mean as in ordinary regression.

The measured schedule deviation for a trip may be fitted to a statistical model that includes sequence number and driver identifier (driver_id). In the model, the sequence number and driver_id may affect both the mean and standard deviation of the schedule deviation data. However, further analysis may assess whether those factors do in fact have a statistical effect on each parameter (mean and standard deviation) in the model.

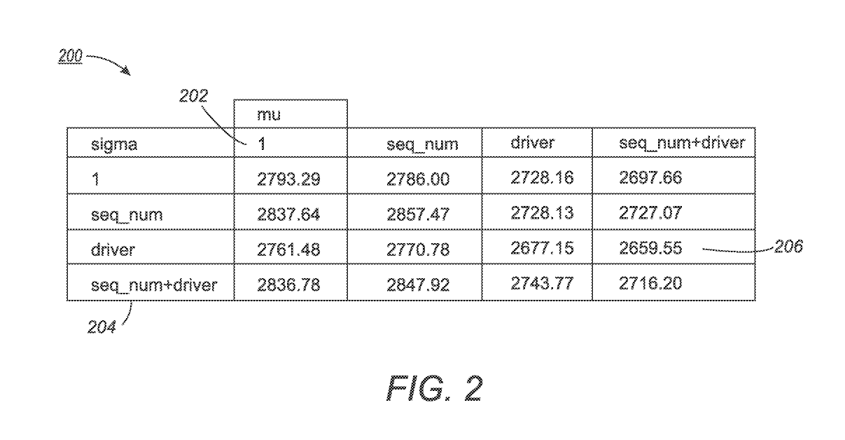

FIG. 2 illustrates a table 200 showing all the combinations of factors that may impact the standard deviation. The horizontal axis 202 represents the factors that contribute to mu, or the mean deviation, from a set schedule for a particular route. The vertical axis 204 represents the factors that contribute to sigma, or the standard deviation, from a set schedule for a particular route. The values in the table 200 represent the BIC values for all the possible combinations affecting mean and standard deviation of schedule deviation.

A method known in the art is to include all combinations of factors and employ a means to rank the models according to effectiveness in fitting the data. For example, there are nine plausible models as illustrated in FIG. 2. There are nine entries corresponding to combinations of [intercept, seq_num, driver_id] for mean and [intercept, seq_num, driver_id] for standard deviation. Each entry is a BIC score. In this example, the lowest BIC score yields the best model. It should be noted that BIC scores as shown in FIG. 2 by way of example only. Additional fitness scores such as Akaike Information Criterion, Deviance Information Criterion and other related scores may be used.

A basic underlying concept in information criteria is to trade off the ability of the model to fit the data (as measured by −2*log likelihood of the fitted model) and the number of parameters use to fit the model. Statistical theory says that the more parameters use to fit the data, the better (i.e., less error) the model will fit the data. Conversely, however, if too many parameters are used, the model over-fits the data and does not adequately capture random error. In the present disclosure, the effect of over fitting the data may be to ascribe uncontrolled variation (e.g., due to traffic, road construction, or weather) to some systematic component such as seq_num or driver_id. BIC has the form −2*log likelihood of fitted model+K*log (number of data points), where K is the number of parameters in the model. The smaller the BIC value, the better the model in the sense that it more accurately ascribes each effect to the variation in the data. Such information criteria are also called penalized likelihood functions because they measure the fidelity of the model to the data by a function of the likelihood but penalize that measure by a function of the number of parameters used in the model. In a penalized likelihood function, a higher number of parameters has an associated higher penalty. For example, the penalty may be calculated by a number (as determined by the scoring and fitting techniques used) multiplied by the number of parameters.

It should be noted that other information criteria for model ranking are known in the art and may be employed in place of BIC. These include, but are not limited to, Akaike's Information Criterion (AIC) and Deviance Information Criterion (DIC). Generally, an information criterion that includes a maximized likelihood term and a penalty for the number of parameters used in the model is called a generalized information criterion (GIC).

Referring again to FIG. 2, the lowest BIC value, value 206 (2659.55) represents the best model for illustrating mean and standard deviation. As shown along the horizontal axis 202, both sequence number and driver affect the mean deviation. However, along the vertical axis 204, only the driver contributes to standard deviation. This may indicate that the individual performance of a driver contributes to schedule deviation more than the sequence of stops taken along the route. Thus, to improve reliability, the transportation provider may focus their attention on driver training or firing their lowest performing drivers.

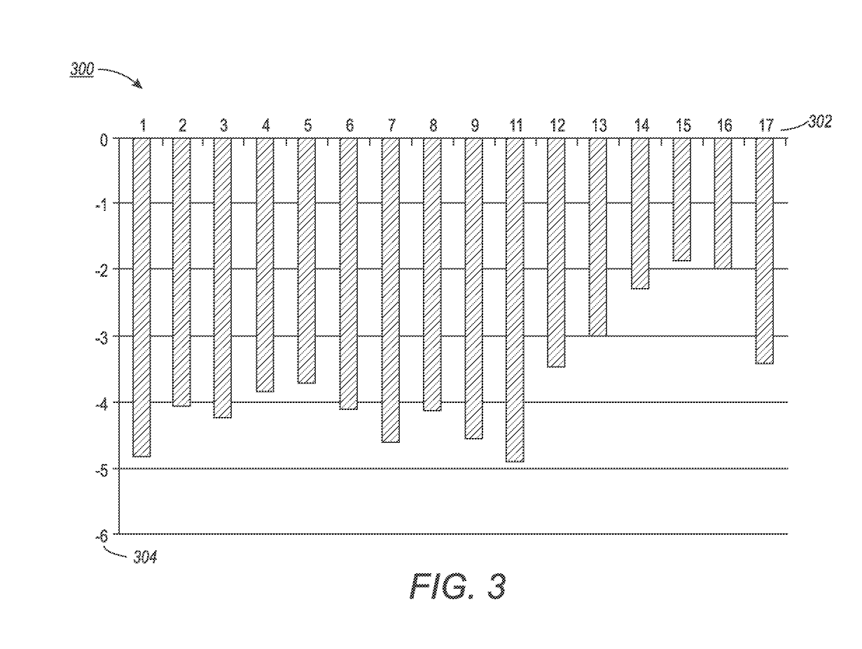

Once the best model is determined, the individual contributing factors may be further analyzed. For example, FIG. 3 illustrates a graph 300 showing the contribution of sequence number to lateness and, thus, schedule deviation. Along the x-axis 302 each individual point on the route is labeled, and the y-axis 304 indicates the contribution of that individual point to the overall lateness. By virtue of their position in the trip, some points are more likely to contribute to lateness.

The graph 300 shows the average effect of sequence number on lateness, where a negative value indicates lateness. As shown in graph 300, the average schedule deviation does in fact vary according to sequence number for this example. Thus the best fitted model may account for the effect of sequence number on average schedule deviation. As the bus trips proceed, it is shown in graph 300 that the schedule slips, but then gets back on track because the average lateness decreases. This effect may be independent of which driver is driving the route.

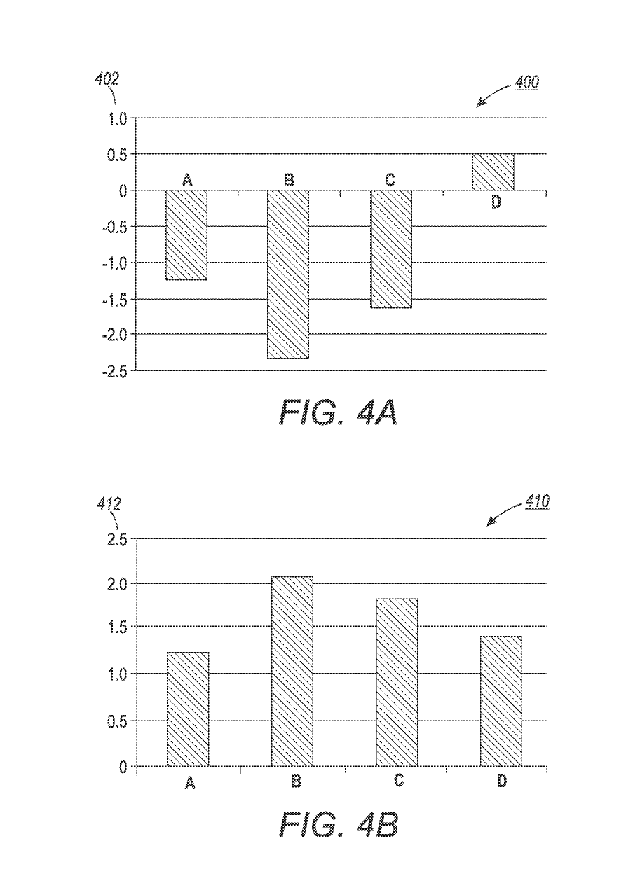

Similarly, the impact of the driver may be further analyzed. For example, FIGS. 4a and 4b illustrate graphs 400, 410 showing how a particular driver may impact lateness. The graph 400 illustrates contributions of lateness by a driver as averaged over the time points on a particular route. The y-axis 402 provides a measurement of the overall lateness as attributed to an individual driver. The closer to zero a driver is on the y-axis 402, the closer to adhering to the schedule. A positive number indicates the driver is early, a negative number indicates the driver is late. As shown in graph 400, driver B is a major contributor to lateness on this route. Additional analysis may be performed to determine exactly why driver B is consistently late. For example, additional analysis may indicate that driver B typically drives the route during rush hour and encounters high levels of traffic. This may prompt the transportation agency to adjust the schedules for that route during rush hours. Conversely, additional analysis may indicate that driver B makes frequent unscheduled stops. This may prompt the transportation agency to adjust driver B's compensation or terminate driver B.

The graph 410 illustrates how often a particular driver deviates from the scheduled route. The y-axis 412 provides a measurement of overall schedule deviation. The closer to zero a driver is, the less the driver deviates from the scheduled route. The higher the number on the y-axis 412, the more often a driver deviates from the schedule route. As shown in graph 410, driver B appears to deviate from the scheduled route more often that the other drivers. Again, this may prompt the transportation agency to perform additional analysis.

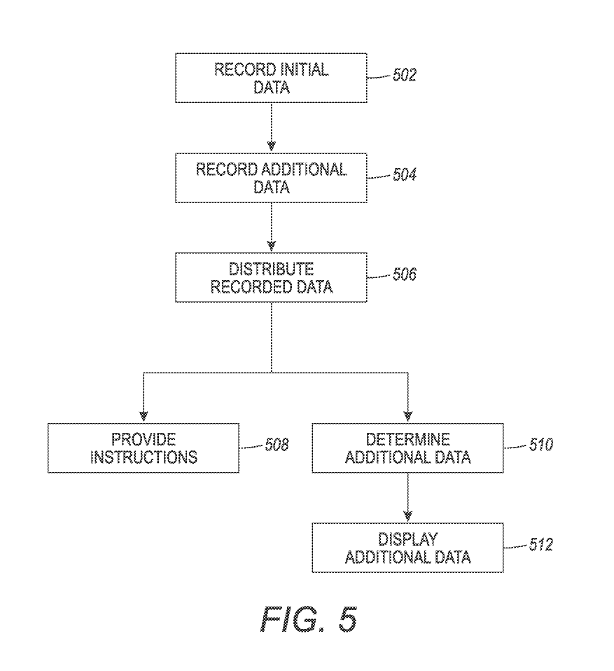

FIG. 5 illustrates a sample flow chart for collecting and displaying various data related to the operation of a transportation vehicle such as a bus. Upon starting operation of the transportation vehicle, a set of initial data may be recorded 502. For example, if the transportation vehicle is a bus, the operator of the bus may enter their driver identification, route number, bus number, and other related information into the CAD/AVL system. The CAD/AVL system may record 502 this data, along with other data such as a timestamp and the geographic location of the bus.

During operation of the bus, the CAD/AVL system may record 504 additional data such as an arrival time at each stop, duration of time spent at each stop, departure time from each stop, travel time between each stop, average travel speed, maximum travel speed, number of times a wheelchair ramp is used, and other related information. Additionally, the operator of the vehicle may manually enter additional information into the CAD/AVL system to be recorded 504. For example, each time a bike rack is accessed the driver may record 504 this information into the CAD/AVL system.

Depending on the capabilities of the CAD/AVL system, the system may distribute 506 the data to a central server according to a set schedule. For example, depending on the network connection of the CAD/AVL system, the system may upload the data each time a new entry is recorded 502, 504. Alternatively, the information may be distributed 506 from the CAD/AVL system at the end of a route or the end of an operator's shift.

Based upon the distributed 506 data, the server or a similar processing device at the transportation agency may perform various additional functions. For example, if the data indicates a particular vehicle is running ahead of schedule, instructions may be provided 508 to the operator of that vehicle to slow down or to spend additional time at the next stop. For example, as shown in FIG. 1, the driver may be instructed to spend less time at the changeover point 10. The instructions may also be based upon historic information related to the driver. For example, if the driver historical is late on a particular route, the transportation agency may provide 508 the driver instructions to reduce or skip a planned stop altogether to maintain schedule adherence.

Additionally, based upon geographic information received from a vehicle, the server may determine that the vehicle is approaching heavy traffic or a crash, and provide 508 the operator of the vehicle instructions to take an alternate route.

Similarly, based upon the distributed 506 information, the transportation agency server may determine 510 additional data. For example, the server may determine 510 that a vehicle will be late to its next four stops. Accordingly, the server may transmit instructions to display 512 this information at an electronic sign or display at each of those four stops, indicating to any waiting passengers that the vehicle is running late. Similarly, the server may determine 510 deviation information related to potential causes for any schedule deviation.

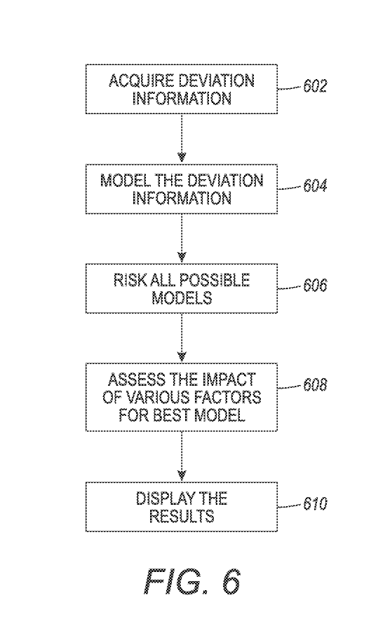

FIG. 6 illustrates a sample process for identifying one or more factors that may contribute to schedule deviation in a transportation system. A system, such as a processing device or a server located at a transportation agency, may acquire 602 deviation information related to a particular transportation trip or route. The deviation information may include various information such as timing information, driver identification, a sequence number, and other related information. It should be noted that one or more of the steps as shown in FIG. 5 may be incorporated into the deviation information acquiring 602 as shown in FIG. 6. For example, the deviation information acquiring 602 may include recording 502 the initial data, recording 504 additional data, and distributing 506 the recorded data.

Based upon the deviation information, the system may model 604 the deviation information. As shown in FIG. 2, modeling 604 the deviation information may include constructing a plurality of models such that each combination of contributing factors is included in at least one model.

Based upon at least one information criterion, such as the Bayesian Information Criterion, the system may rank 606 each of the models to determine which of the models is the most representative of which factors contribute to schedule deviation.

Each of the contributing factors in the ranked 606 model may be assessed 608 to determine the impact of that individual factor in the overall schedule deviation to produce a result set. For example, as shown in FIG. 2, both driver identification and sequence number are assessed to determine which is the highest contributing factor. The results may be displayed 610 to a user of the system via a display device. Based upon the results, additional analysis may be done, or a set of suggested actions may be determined. For example, the suggested actions may include additional driver training, adjustment to a driver's compensation, terminating a driver, and other similar actions.

In the examples as shown above, the driver was the major contributing factor to the schedule deviation. It should be noted that this is shown by way of example one and other factors may be the major contributor to low reliability and high schedule deviation. For example, weather, traffic, construction, and other similar factors may have a greater impact on schedule deviation that the driver.

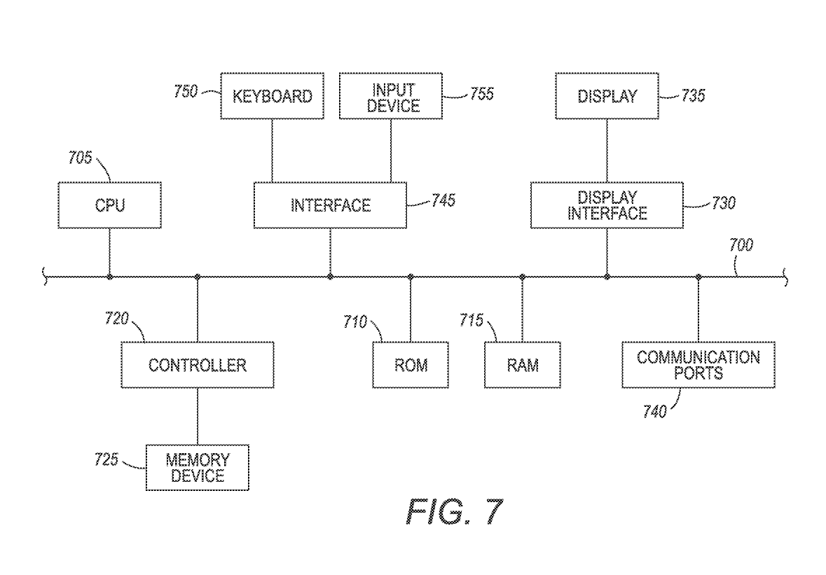

The contingency table and regression model calculations and derivations as described above may be performed and implemented by an operator of a computing device located at an operations center (e.g., a central operations center for a public transportation provider). FIG. 7 depicts a block diagram of internal hardware that may be used to contain or implement the various computer processes and systems as discussed above. An electrical bus 700 serves as the main information highway interconnecting the other illustrated components of the hardware. CPU 705 is the central processing unit of the system, performing calculations and logic operations required to execute a program. CPU 705, alone or in conjunction with one or more of the other elements disclosed in FIG. 7, is a processing device, computing device or processor as such terms are used within this disclosure. Read only memory (ROM) 710 and random access memory (RAM) 715 constitute examples of memory devices.

A controller 720 interfaces with one or more optional memory devices 725 to the system bus 700. These memory devices 725 may include, for example, an external or internal DVD drive, a CD ROM drive, a hard drive, flash memory, a USB drive or the like. As indicated previously, these various drives and controllers are optional devices. Additionally, the memory devices 725 may be configured to include individual files for storing any software modules or instructions, auxiliary data, incident data, common files for storing groups of contingency tables and/or regression models, or one or more databases for storing the information as discussed above.

Program instructions, software or interactive modules for performing any of the functional steps associated with the processes as described above may be stored in the ROM 710 and/or the RAM 715. Optionally, the program instructions may be stored on a tangible computer readable medium such as a compact disk, a digital disk, flash memory, a memory card, a USB drive, an optical disc storage medium, such as a Blu-ray™ disc, and/or other recording medium.

An optional display interface 730 may permit information from the bus 700 to be displayed on the display 735 in audio, visual, graphic or alphanumeric format. Communication with external devices may occur using various communication ports 740. A communication port 740 may be attached to a communications network, such as the Internet or a local area network.

The hardware may also include an interface 745 which allows for receipt of data from input devices such as a keyboard 750 or other input device 755 such as a mouse, a joystick, a touch screen, a remote control, a pointing device, a video input device and/or an audio input device.

It should be noted that a public transportation system is described above by way of example only. The processes, systems and methods as taught herein may be applied to any environment where performance based metrics and information are collected for later analysis, and provided services may be altered accordingly based upon the collected information to improve reliability or schedule adherence.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of identifying factors that contribute to schedule deviation in a transportation system, the method comprising:
collecting, at a processing device, operating information related to the operation of a vehicle along a transportation route;
determining, at the processing device, schedule deviation information for the transportation route based upon the operating information, the schedule deviation information comprising at least an identification of a driver and a sequence number;
constructing, by the processing device, a plurality of models, each of the plurality of models including at least one combination of factors that contribute to schedule deviation;
ranking, by the processing device, each of the plurality of models according to at least one information criterion;
assessing, by the processing device, an impact of the driver and the sequence number on a highest ranked model to produce a results set, wherein the results set comprises at least a highest ranked model showing at least one combination of factors that most contributes to schedule deviation; and
presenting, by the processing device, the results set.

2. The method of claim 1, wherein the sequence number comprises an order of stops taken by the driver along the route.

3. The method of claim 1, wherein the plurality of models comprise one or more regression models.

4. The method of claim 1, wherein the at least one information criterion comprises at least one of a Bayesian Information Criterion, an Akaike's Information Criterion, a Deviance Information Criterion and a Generalized Information Criterion.

5. The method of claim 1, wherein the factors comprise at least the driver and the sequence number.

6. The method of claim 1, wherein the results set comprises suggested actions to be taken to reduce schedule deviation.

7. The method of claim 6, wherein the suggested actions comprise at least one of additional driver instruction, driver compensation adjustment and driver termination.

8. A device for predicting a future occurrence of a transportation system incident, the device comprising:
a processor; and
a computer readable medium operably connected to the processor, the computer readable medium containing a set of instructions configured to instruct the processor to perform the following:
collect operating information related to the operation of a vehicle along a transportation route,
determine schedule deviation information for the transportation route based upon the operating information, the schedule deviation information comprising at least an identification of a driver and a sequence number,
construct a plurality of models, each of the plurality of models including at least one combination of factors that contribute to schedule deviation,
rank each of the plurality of models according to at least one information criterion,
assess an impact of the driver and the sequence number on a highest ranked model to produce a results set, wherein the results set comprises at least a highest ranked model showing at least one combination of factors that most contributes to schedule deviation, and
present the results set.

9. The device of claim 8, wherein the sequence number comprises an order of stops taken by the driver along the route.

10. The device of claim 8, wherein the plurality of models comprise one or more regression models.

11. The device of claim 8, wherein the at least one information criterion comprises at least one of a Bayesian Information Criterion, an Akaike's Information Criterion, a Deviance Information Criterion and a Generalized Information Criterion.

12. The device of claim 8, wherein the factors comprise at least the driver and the sequence number.

13. The device of claim 8, wherein the results set comprises suggested actions to be taken to reduce schedule deviation.

14. The device of claim 13, wherein the suggested actions comprise at least one of additional driver instruction, driver compensation adjustment and driver termination.

15. A method of identifying factors that contribute to schedule deviation in a transportation system, the method comprising:
collecting, by a processing device, operating information related to the operation of a vehicle along a transportation route, wherein the operating information comprises at least timing information and geographic information for the vehicle along the transportation route;
determining, by the processing device, schedule deviation information for the transportation route based upon the operating information, the schedule deviation information comprising at least an identification of a driver of the vehicle and a sequence number for the transportation route;
constructing, by the processing device, a plurality of models, each of the plurality of models including at least one combination of factors that contribute to schedule deviation, the factors comprising at least the driver and the sequence number;
ranking, by the processing device, each of the plurality of models according to at least one information criterion;
assessing, by the processing device, an impact of the driver and the sequence number on a highest ranked model to produce a results set, wherein the results set comprises:
at least a highest ranked model showing at least one combination of factors that most contributes to schedule deviation, and
at least one suggested action to be taken to reduce schedule deviation;
presenting, by the processing device, the results set; and
implementing the at least one suggested action.

16. The method of claim 15, wherein the sequence number comprises an order of stops taken by the driver along the route.

17. The method of claim 15, wherein the plurality of models comprise one or more regression models.

18. The method of claim 15, wherein the at least one information criterion comprises at least one of a Bayesian Information Criterion, an Akaike's Information Criterion, a Deviance Information Criterion and a Generalized Information Criterion.

19. The method of claim 15, wherein the suggested actions comprise at least one of additional driver instruction, driver compensation adjustment and driver termination.
